(19) United States
(12) Patent Application Publication
(10) Pub. No.: US 2025/0283643 A1
(43) Pub. Date: Sep. 11, 2025

(54) METHOD FOR OPERATING A HEAT EXCHANGER AND APPARATUS HAVING A HEAT EXCHANGER

(71) Applicant: GÜNTNER GMBH & CO. KG, Fürstenfeldbruck (DE)

(72) Inventor: Jörg KÖCHER, Utting (DE)

(21) Appl. No.: 18/861,798

(22) PCT Filed: May 25, 2023
(86) PCT No.: PCT/EP2023/064110

§ 371 Date: Oct. 30, 2024

(30) Foreign Application Priority Data
May 27, 2022 (DE) 10 2022 113 411.3

(51) Int. Cl. F25B 47/02; F25B 49/02

(52) U.S. Cl. CPC F25B 47/02; F25B 49/02; F25B 2347/02

(57) ABSTRACT

A device, having a heat exchanger, which includes has a pipe which carries a cooling medium, wherein the pipe is connected to several cooling fins of the heat exchanger, having a fan for conveying a volumetric air flow, having a heating device for defrosting the heat exchanger, having a device for photographic imaging and having a control unit, wherein the control unit is set up for detecting an icing state of the heat exchanger and for determining a defrosting time on the basis of an evaluation of first photographic images, wherein the control unit is set up for controlling a defrosting operation carried out by the heating device on the basis of an evaluation of second photographic images, and wherein the evaluation of first photographic images is different from the evaluation of second photographic images.

### CROSS-REFERENCE TO RELATED APPLICATIONS

This application is a 35 U.S.C. § 371 National Stage patent application of PCT/EP2023/064110, filed on 25 May 2023, which claims the benefit of German patent application 10 2022 113 411.3, filed on 27 May 2022, the disclosures of which are incorporated herein by reference in their entirety,

### TECHNICAL FIELD

The present disclosure relates to a method for operating a heat exchanger and a device with a heat exchanger.

### BACKGROUND

Heat exchangers are used to remove heat from a system to be cooled or to introduce heat into a system to be heated. In the field of refrigeration technology, heat exchangers are used to remove heat from a volume to be cooled by transferring a cooling medium from the liquid to the gaseous phase, wherein the heat exchanger is used as an evaporator. Similarly, a heat exchanger can be used in the field of heating technology to absorb ambient heat from the outside air in order to provide heat for a building to be heated in conjunction with a heat pump. Conversely, such a heat exchanger can also be used as a condenser or recooler to release heat into the environment.

Regardless of the particular application, it is crucial for the reliable and fault-free functioning of the heat exchanger that heat transfer between the heat exchanger and its surroundings is not restricted by interference that isolates the heat exchanger from its surroundings. Such interfering influences are, for example, soiling or icing of the heat exchanger, which can accumulate between the fins or fin packs of the heat exchanger.

Heat exchangers often have fins or fin packs in order to provide the largest possible surface area available for heat transfer while keeping the size small. In the practical operation of such a heat exchanger, moisture from the surroundings of the fins may condense on their surfaces, causing these surfaces and the spaces between the fins to ice up. Due to the insulating effect of this icing, the heat transfer between the environment of the heat exchanger and its fins or the corresponding liquid inside the heat exchanger is Impaired. In addition, the air flow through the heat exchanger is impaired, which increases the pressure loss and reduces the performance as less air flows through the heat exchanger. In this state, the heat exchanger may no longer provide the required cooling capacity or heat output. This can lead to the destruction of the cooled goods or to the failure of a system to be cooled. Furthermore, icing can damage the components of the heat exchanger.

In order to remove the icing, it is known to defrost the heat exchanger using a heating device. Such defrosting should be carried out as efficiently as possible. If defrosting is carried out too frequently or over too long a period, an unnecessarily large amount of heating energy is introduced into a volume that is to be cooled, for example, which then has to be removed with the aid of the heat exchanger in order to maintain or set the intended cooling temperature. If defrosting is carried out too infrequently or for too short a period, defrosting is not effective and the functionality of the system in question is impaired. Well-known methods of defrosting include electric defrosting, hot gas defrosting, hot brine defrosting and water or air defrosting.

The document U.S. Pat. No. 11,221,173 B2 describes a device and a method for defrosting a heat exchanger, wherein ice formation is monitored by means of an infrared camera and defrosting is controlled by means of an infrared camera. The ice formation is evaluated on the basis of brightness within the images of the infrared camera, wherein a high brightness is correlated with low ice formation and a lower brightness is correlated with higher ice formation. The disadvantage here is that an infrared camera is only suitable for monitoring ice formation and determining the time of defrosting to a limited extent and provides imprecise results. This means that defrosting may occur too early or too late.

Document KR102041145B1 relates to a device and a method for defrosting a heat exchanger, wherein the ice formation is monitored by means of a camera and defrosting is controlled by means of the camera. The disadvantage here is that a conventional camera is only suitable for controlling defrosting and for determining the end of defrosting to a limited extent and provides imprecise results. This means that defrosting may take too long or be too short.

### SUMMARY

Against this background, the present disclosure is based on the technical problem of providing a method for operating a heat exchanger and a device having a heat exchanger which, in particular, enable efficient defrosting and reliable operation of the heat exchanger.

The technical problem described above is solved in each case by the independent claims. Further designs of the disclosure result from the dependent claims and the following description.

According to a first aspect, the disclosure relates to a method comprising the method steps of: operating a heat exchanger; detecting an icing state of the heat exchanger and determining a defrosting time of the heat exchanger on the basis of an evaluation of first photographic images of the heat exchanger; starting a defrosting process of the heat exchanger, which is carried out by means of a heating device, at the defrosting time and controlling the defrosting process on the basis of an evaluation of second photographic images of the heat exchanger; wherein the evaluation of first photographic images is different from the evaluation of second photographic images.

The fact that the evaluation used to determine the defrosting time differs from the evaluation used to control the defrosting process means that both the determination of the defrosting time and the control of the defrosting process can be improved. This is because the respective tasks underlying the determination of the defrosting time and the control of the defrosting process differ significantly. For example, the aim of determining the defrosting time and the evaluation on which this determination of the defrosting time is based is to observe and evaluate a condition, namely the icing condition of the heat exchanger, while the aim of controlling the defrosting process Is to use the heating device as efficiently as possible to defrost the heat exchanger. The different design of the evaluation of the first photographic images from the evaluation of the second photographic images therefore enables both an optimization of the determination of the defrosting time and an optimization of the control of the defrosting process independently of each other, without these influencing or impairing each other. This ensures efficient defrosting and reliable operation of the heat exchanger.

It may be provided that the first photographic images are photographic images of a visible wavelength range.

It may be provided that a light source is provided to illuminate the heat exchanger for taking photographic images of the visible wavelength range. Such a light source may be a flash, a lamp or the like.

When reference is made in the present text to a visible wavelength range, this refers to a wavelength range recognizable by the human eye. In particular, the wavelength range can have wavelengths of approximately 360 nanometers to 830 nanometers, and in particular approximately 400 nanometers to 780 nanometers. The first photographic images are therefore comparable in particular to conventional photographic images which can be produced with conventional digital cameras, as are also known from the consumer goods sector.

The evaluation of the first photographic images is therefore in particular an evaluation of digital, photographic images of the visible wavelength range.

It may be provided that the first photographic images are photographic images of Infrared reflections of the heat exchanger. It may be provided that the first photographic image is an infrared image of the heat exchanger.

It may be provided that an infrared light source, such as an infrared spotlight or the like, is provided to illuminate the heat exchanger for taking photographic infrared images.

It may be provided that the evaluation of the first photographic images is carried out by means of image evaluation software, wherein two or more reference images of photographic images of the visible wavelength range are provided to the image evaluation software and wherein a comparison of the reference images with a respective first photographic image is carried out by means of the image evaluation software. Based on the comparison of such a first photographic image with the reference images, the image evaluation software can be used, for example, to determine the amount of ice to be detected on the heat exchanger in order to determine the time of defrosting. This makes it easy to automate the determination of the defrosting time.

The image evaluation software can be AI-based. AI-based image evaluation has the advantage that the quality of the image evaluation can be increased as the amount of data increases. AI-based image evaluation also has the advantage that the evaluation can be applied to different sizes and types of heat exchanger, using a common database.

When the abbreviation “AI” is used in this document, it stands for “artificial Intelligence” and is synonymous with the related topics of “machine learning” and “deep learning”,

Overall, the detection of an icing degree of the heat exchanger and a necessary or unnecessary defrosting to be derived from this can be mapped as a classification problem by means of an AI, wherein a mapping function is generated using training data, which classifies an icing degree of the heat exchanger as either critical or non-critical based on image data, so that defrosting is started or the heat exchanger can initially continue to be operated without defrosting. It may be provided that the mapping function is further improved on the basis of the image data processed during operation, so that it is a “learning” algorithm. In other words, the quality of the imaging function can be improved as the amount of data increases.

It may be provided that a first group of reference images of photographic images of the visible wavelength range shows an icing condition of the heat exchanger which requires defrosting and a second group of reference images of photographic images of the visible wavelength range shows an icing condition of the heat exchanger which does not require defrosting, wherein the defrosting time is defined if one or more of the first photographic images are assigned by the image evaluation software to the first group of photographic images of the visible wavelength range.

In particular, the reference images of photographic images of the visible wavelength range can be divided into two or more classes according to the icing degree to be recognized on the reference images. If, for example, a machine learning algorithm is used here, the reference images divided into classes can also be referred to as training data for a classifier.

It may be provided that reference images have been manually classified by skilled personnel. Alternatively or additionally, it may be provided that reference images have been classified on the basis of software, wherein, for example, one or more parameters, such as an optically recognizable ice surface, sensor data at the time of recording the relevant reference image, such as a pressure, a temperature or the like, are taken into account,

When sensor data is referred to here, it refers to one or more of the values listed below: temperature data of the environment and/or a refrigerant, pressure of a refrigerant, in particular at an inlet and outlet of the heat exchanger; air pressure, in particular a differential pressure between an ambient pressure and a pressure between a fan and a fin arrangement, wherein, for example, a pressure loss is measured on a side of a fin arrangement facing away from the fan.

For example, it may be provided that the reference images of photographic images of the visible wavelength range are divided into up to 40 classes according to the icing degree to be recognized on the reference images, in particular divided into up to 20 classes, in particular further divided into up to ten classes,

In particular, it may be provided that the reference images are assigned to the first group or the second group on the basis of their respective class, wherein one or more classes are assigned to the first group, wherein one or more classes are assigned to the second group and wherein a class that is assigned to the first group is not assigned to the second group, and vice versa. In particular, it may be provided that two or more classes are assigned to each group.

Based on the assignment of the reference images to the first group or the second group on the basis of their respective class, wherein the respective class reflects the icing degree, a so-called target function can be defined, which makes it possible to assign a respective first photographic image either to the first group or to the second group.

According to a further design of the method, it may be provided that the second photographic images are photographic images of a non-visible wavelength range. When reference is made here to a non-visible wavelength range, this refers in particular to a wavelength range from 780 nm to 1 mm.

According to a further design of the method, it may be provided that the second photographic images are thermal images. Although some of the literature does not refer to thermal images as “photographic images”, for the purposes of the present text, thermal images are photographic images or photographic images of a non-visible wavelength range. Thermal images depict temperature differences of an object.

The second photographic images can therefore in particular have infrared images and/or thermal images.

The evaluation of first photographic images and the evaluation of second photographic images can therefore differ in particular in that the first photographic Images are photographic images of the visible wavelength range and that the second photographic images are photographic images of the non-visible wavelength range, It has been shown that photographic images of the visible wavelength range enable a defrosting time to be determined reliably and precisely, while photographic images of the non-visible wavelength range are particularly suitable for controlling a defrosting process.

In particular, the non-visible wavelength range can be the infrared range.

The second photographic images can be evaluated using image evaluation software, wherein two or more reference images of photographic images of the non-visible wavelength range are provided to the image evaluation software and wherein the reference Images are compared with a respective second photographic image using the image evaluation software. Based on the comparison of such a second photographic image with the reference images, the image evaluation software can be used, for example, to determine an amount of ice to be detected on the heat exchanger in order to determine the end of defrosting. This makes it easy to automate the determination of the end of defrosting.

The image evaluation software can be AI-based. AI-based image evaluation has the advantage that the quality of the image evaluation can be increased as the amount of data increases. AI-based image evaluation also has the advantage that the evaluation can be applied to different sizes and types of heat exchanger, using a common database.

According to one design of the method, it may be provided that a first group of reference images of photographic images of the non-visible wavelength range shows an icing condition of the heat exchanger which requires defrosting and a second group of reference images of photographic images of the non-visible wavelength range shows an icing condition of the heat exchanger which does not require defrosting, wherein a defrosting process is terminated if one or more of the second photographic images are assigned by the image evaluation software to the second group of reference images of photographic images of the non-visible wavelength range.

It may be provided that the reference images of photographic images of the non-visible wavelength range are divided into two or more classes according to the icing degree to be recognized on the reference images. If, for example, a machine learning algorithm is used here, the reference images divided into classes can also be referred to as training data for a classifier.

Furthermore, it may be provided that reference images have been manually classified by skilled personnel. Alternatively or additionally, it may be provided that reference images have been classified on the basis of software, wherein, for example, one or more parameters, such as an optically recognizable ice surface, sensor data at the time of recording the relevant reference image, such as a pressure, a temperature or the like, are taken into account.

For example, it may be provided that the reference images of photographic images of the non-visible wavelength range are divided into up to 40 classes according to the icing degree to be recognized on the reference images, in particular into up to 20 classes, in particular into up to ten classes.

According to one design of the method, it may be provided that the reference images are assigned to the first group or the second group on the basis of their respective class, wherein one or more classes are assigned to the first group, wherein one or more classes are assigned to the second group, wherein a class that is assigned to the first group is not assigned to the second group, and vice versa. In particular, it may be provided that two or more classes are assigned to each group.

The evaluation of second photographic images can be a thermal image evaluation of back-radiated intensities in the non-visible wavelength range, wherein the second photographic images are thermal images. Such thermal images can be recorded in particular without an external light source using only the relevant sensor of a thermal imaging camera in order to record the heat signature of the heat exchanger. While a conventional digital camera and also an infrared camera capture reflected light and may be dependent on an additional light source, a thermal imaging camera does not require such a light source.

This type of thermal image evaluation enables targeted control of the heating device in order to ensure reliable defrosting or defrosting on the one hand and to avoid excessive heat input that is not required for defrosting on the other.

In addition, photographic images of the visible wavelength range can be used to control the defrosting process. Thus, according to one design of the method, both photographic images of the visible wavelength range and photographic images of the non-visible wavelength range are evaluated to control the defrosting process.

In order to enable a more precise or improved evaluation of the second photographic images, it may be provided that the second photographic images of the evaluation are provided in grayscale. Such representations in grayscale enable an improved, software-based evaluation of the photographic images of the non-visible wavelength range.

According to one design of the method, it may be provided that a first time interval, which is present between the provision and evaluation of two successive photographic images of the first photographic images, is greater than a second time interval, which is present between the provision and evaluation of two successive photographic images of the second photographic images,

In particular, It may be provided that the first interval is more than twice, more than five times, more than ten times or more than 50 times the second time interval. For example, the first time interval may be 5 minutes, 10 minutes, 15 minutes, 30 minutes, 60 minutes or more, while the second time interval may be less than 10 minutes, less than 5 minutes or less than 1 minute. Since ice formation on the heat exchanger often occurs over a longer period of time in practice, longer time intervals are sufficient to monitor this ice formation and determine the defrosting time. In contrast, defrosting takes place more quickly due to the active heat input by means of the heating device, so that shorter time intervals are used to monitor and control such a defrosting process in order to avoid excessive heat input by means of the heating device. The adaptation of the time intervals serves in particular to reduce the amount of data.

It may be provided that the first time interval is shortened as the icing degree Increases. This ensures that the optimum time to start defrosting is not missed.

In addition to photographic images, sensor data can also be used to determine the icing status and/or the defrosting time and/or to control the defrosting process, wherein one or more of the sensors listed below can be used: Temperature sensor, pressure sensor, humidity sensor.

For example, it may be provided that one or more sensor signals are used to check the plausibility of the result of the evaluation of the first photographic images and/or the evaluation of the second photographic images. If, for example, the evaluation of a first photographic image shows that a critical icing condition has been reached which requires defrosting, but the evaluation of one or more sensor signals shows, in contrast, that no critical icing condition has been reached, the evaluation of one or more further first photographic images can be carried out in order to check the necessity of defrosting. Alternatively or additionally, an error message and/or a fault message can be output for the aforementioned case of sensor data contradicting the evaluation of the first photographic images.

If the plausibility check is positive, wherein both one or more sensor signals and the evaluation of the first photographic images detect a critical icing condition, the time of defrosting can be determined.

This principle can also be applied to determining the end of defrosting.

It may be provided that a number of photographic imaging devices, in particular cameras, for capturing the second photographic images is greater than a number of cameras for capturing the first photographic images.

Alternatively or additionally, it may be provided that exactly one device for photographic imaging, in particular a camera, is provided for capturing the first photographic images.

It may be provided that two or more photographic imaging devices, in particular cameras, are provided for capturing the second photographic images.

Alternatively or additionally, it may be provided that a plurality of devices for photographic imaging, in particular cameras, are provided for capturing the second photographic images, which are distributed along a longitudinal extension of the heat exchanger.

If reference is made here about determining the time of defrosting, it may be provided, for example, that defrosting is started immediately as soon as the evaluation of the first photographic images shows that an icing condition has been reached that requires defrosting. Alternatively, it may be provided that the defrosting time can be determined for the future based on the evaluation of the first photographic images. For example, an icing condition can be used to determine a time in the future when a critical icing condition is likely to be reached that impairs the reliable operation of the heat exchanger, so that the defrosting time is set before this time in the future. This is because defrosting preferably takes place at a time when the available output of the heat exchanger is reliably within a specified target output range,

It may be provided that the evaluation of the first photographic images and/or the evaluation of the second photographic images is carried out at least partially by means of a server, wherein a controller of the heating device is connected to the server via a wired or wireless data connection.

Alternatively or additionally, it may be provided that the evaluation of the first photographic images and/or the evaluation of the second photographic images is carried out at least partially by means of a computer assigned to the heat exchanger and the heating device, wherein a controller of the heating device is connected to the computer via a wired or wireless data connection.

The evaluation can therefore take place online and/or offline. For example, it may be provided that a connection to the server as part of a first setup of the heat exchanger is established in order to carry out a data comparison, while the evaluation takes place locally during operation using the computer of the device and, for example, a connection to the server is only established at predefined intervals for further data comparison.

Alternatively, it may be provided that the evaluation of the first photographic images and/or the evaluation of the second photographic images is carried out exclusively by means of the server and no evaluation is carried out by means of a computer of the device.

Alternatively, it may be provided that the evaluation of the first photographic images and/or the evaluation of the second photographic images is carried out exclusively by means of the computer of the device and no evaluation is carried out by means of the server.

As a result of the evaluation of the first photographic images and/or as a result of the evaluation of the second photographic images, a service message and/or an alarm message can be generated and output.

A service message is a notification of a maintenance requirement that affects, for example, the heat exchanger and/or the heating device. Such a maintenance requirement is not to be regarded as acute, meaning that the heat exchanger and the heating device are not restricted in their function at the time of the service notification,

An alarm message is a message regarding a partial or complete failure or regarding a malfunction of the heat exchanger and/or the heating device. The alarm message therefore signals an acute, immediate need for action in order to restore the function of the heat exchanger and/or the heating device.

It may be provided that a number of photographic imaging devices, in particular cameras, for capturing the second photographic images is greater than a number of cameras for capturing the first photographic images.

Alternatively or additionally, it may be provided that exactly one device for photographic imaging, in particular a camera, is provided for capturing the first photographic images.

It may be provided that two or more photographic imaging devices, in particular cameras, are provided for capturing the second photographic images.

Alternatively or additionally, it may be provided that a plurality of devices for photographic imaging, in particular cameras, are provided for capturing the second photographic images, which are distributed along a longitudinal extension of the heat exchanger.

The method can be a method for cooling a walk-in cooling volume.

The method can be a method for heating a walk-in heating volume,

According to a second aspect, the disclosure relates to a device having a heat exchanger, wherein the heat exchanger has a pipe which carries a cooling medium, wherein the pipe is connected to a plurality of cooling fins of the heat exchanger and having a fan for conveying a volume flow of air, having a heating device for defrosting the heat exchanger, with a device for photographic imaging and having a control unit, wherein the control unit is set up for detecting an icing condition of the heat exchanger and for determining a defrosting time on the basis of an evaluation of first photographic images, wherein the control unit is set up for controlling a defrosting process carried out by means of the heating device on the basis of an evaluation of second photographic images, and wherein the evaluation of first photographic images is different from the evaluation of second photographic images.

The fact that the evaluation used to determine the defrosting time differs from the evaluation used to control the defrosting process means that both the determination of the defrosting time and the control of the defrosting process can be improved. This is because the respective tasks underlying the determination of the defrosting time and the control of the defrosting process differ significantly. For example, the aim of determining the defrosting time and the evaluation on which this determination of the defrosting time is based is to observe and evaluate a condition, namely the icing condition of the heat exchanger, while the aim of controlling the defrosting process is to use the heating device as efficiently as possible to defrost the heat exchanger. The different design of the evaluation of the first photographic images from the evaluation of the second photographic images therefore makes it possible to optimize both the determination of the defrosting time and the control of the defrosting process independently of each other, without these influencing or impairing each other.

All the structural or functional features already mentioned above with reference to the method in question can also be the subject matter of the device according to the disclosure. All method aspects described below with reference to the device in question can be the subject matter of the method according to the disclosure.

The first photographic images can be photographic images of a visible wavelength range. This may be the visible wavelength range described above with reference to the method according to the disclosure.

The second photographic images can be photographic images of a non-visible wavelength range. This can be the non-visible wavelength range described above with reference to the method according to the disclosure.

It may be provided that the photographic imaging device comprises a first camera with a sensor for photographic imaging in the visible wavelength range and a second camera with a sensor for photographic imaging in the non-visible wavelength range, or that the photographic imaging device comprises a camera for photographic Imaging in both the visible wavelength range and the non-visible wavelength range.

In particular, it may be provided that the photographic imaging device comprises an infrared camera and/or a thermal imaging camera. The photographic imaging device can be set up to produce photographic images of the visible wavelength range. The photographic imaging device can be set up to produce photographic images of the non-visible wavelength range, namely in the form of infrared images and/or thermal images. The photographic imaging device can be set up to create thermal images.

It may be provided that the photographic imaging device is set up to output photographic images of the non-visible wavelength range in grayscale. In particular, it may be provided that the control unit is set up to process second photographic images provided in grayscale.

The device can have one or more of the sensors listed below:

Temperature sensor, pressure sensor, humidity sensor.

The device can be a cooling system for cooling a walk-in cooling volume.

The device can be a heating system for heating a walk-in heating volume.

When reference is made in the present text to a heating device with regard to the method or the device, this may, for example, be an electrical heating device which has, for example, one or more heating rods, heating coils or heating loops. Alternatively or additionally, a heating device can be provided that guides a fluid through pipes. Alternatively or additionally, a heating device can be provided that has a hot air heater. The heating device can be realized by a reverse operation of the heat exchanger. The heating device can have a brine defrosting system. Defrosting can be carried out by electrical defrosting, hot gas defrosting, warm brine defrosting, water defrosting or air defrosting.

### BRIEF DESCRIPTION OF THE DRAWINGS

The disclosure is described in more detail below with reference to a drawing illustrating exemplary embodiments. The drawings show schematically in each case:

FIG. 1 shows a device according to the disclosure in a perspective view from the front;

FIG. 2 shows the device from FIG. 1 without housing in a perspective view from behind;

FIG. 3 shows the heat exchanger of the device in FIG. 1 with continuous heating rods;

FIG. 4 shows a heat exchanger for a device according to FIG. 1 with non-continuous heating rods;

FIG. 5 shows icing conditions of the heat exchanger from FIG. 3; and

FIG. 6 shows a flow chart of a method according to the disclosure.

### DETAILED DESCRIPTION OF THE DRAWINGS

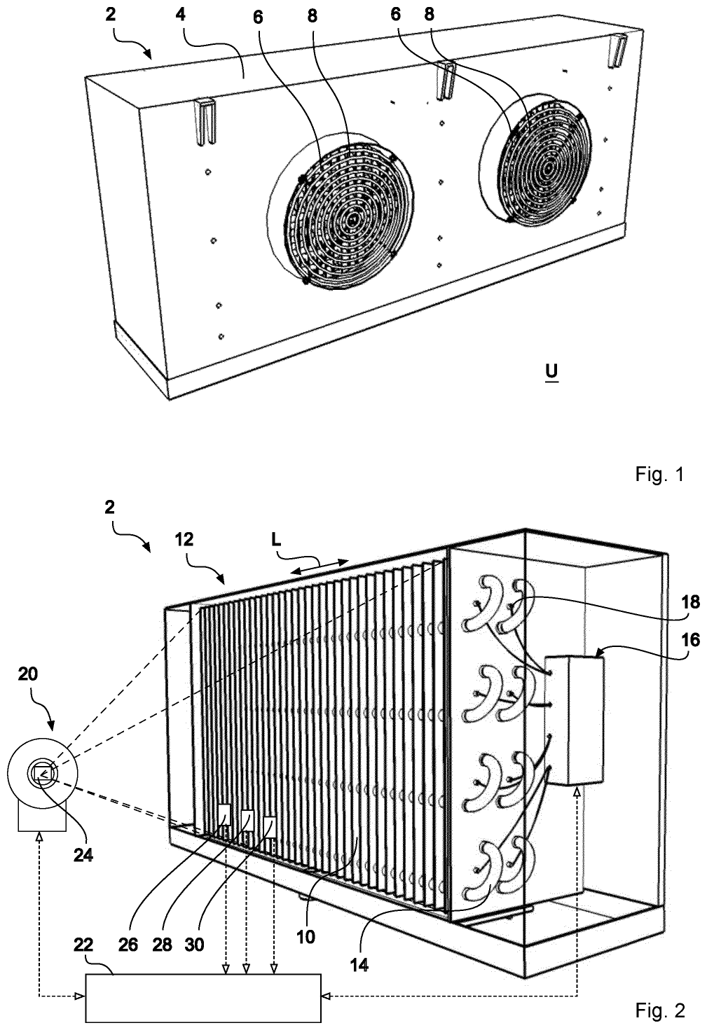

FIG. 1 shows a device 2 according to the disclosure. The device 2 is a cooling system 2. The cooling system 2 can be used, for example, to cool a walk-in cooling volume.

The cooling system 2 has a housing 4 that supports protective grilles 6 of fans 8 of the cooling system 2. The fans 8 are used to convey air from an environment U along fins 10 of a heat exchanger 12 of the cooling system 2. The heat exchanger 12 is described below with reference to FIG. 2.

The heat exchanger 12 is located inside the cooling system 2, so that the housing 4 is hidden to illustrate the heat exchanger 12 in FIG. 2. The heat exchanger 12 has a plurality of flat or plate-shaped fins 10 which are lined up essentially parallel to each other along a longitudinal extension L of the heat exchanger 12.

The fins 10 are traversed by a pipe 14 of the heat exchanger 12, which carries a cooling medium. The fins 10 can also be referred to as cooling fins 10. The cooling fins 10 are connected to the pipe 14 of the heat exchanger 12.

The device 2 has a heating device 16 with heating rods 18 for defrosting the heat exchanger 12. The heating rods 18 also pass through the cooling fins 10 along the longitudinal direction L and are connected to the cooling fins 10.

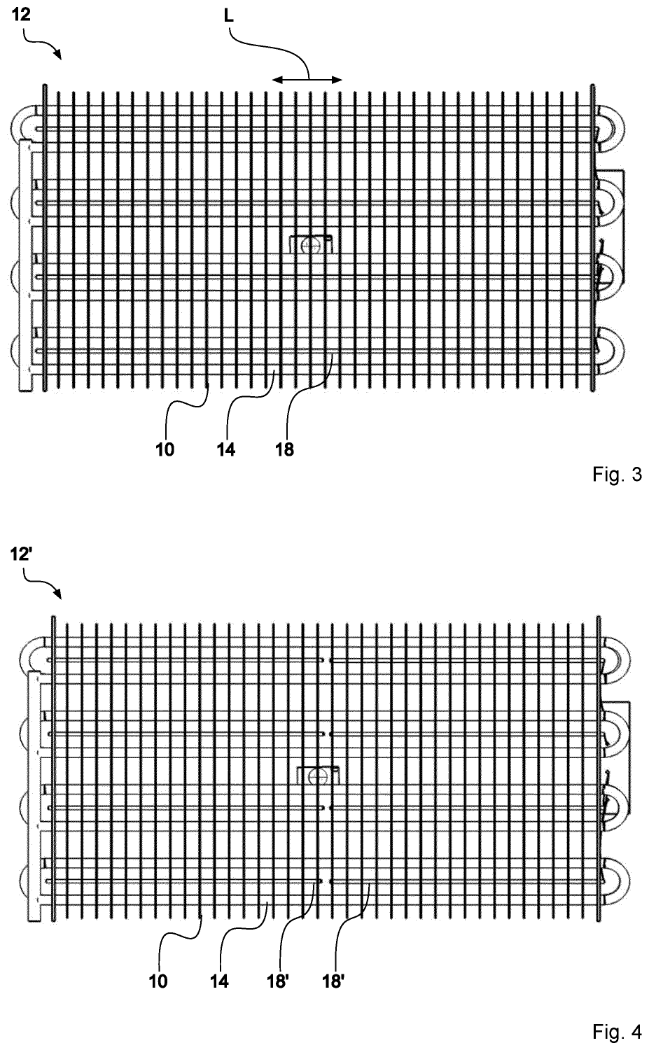

FIG. 3 shows the cooling fins 10 of the heat exchanger 12 with the heating rods 18 and the pipe 14. According to FIG. 3, the heating rods 18 completely penetrate the arrangement of the fins 10 along the longitudinal direction L over the entire length.

FIG. 4 shows an alternative design of a heat exchanger 12′, which can also be used in a device 2 according to the disclosure. The heat exchanger 12′ according to FIG. 4 differs from the heat exchanger 12 according to FIG. 3 in that heating rods 18′ are provided, which only penetrate the arrangement of fins 10 over a partial length when viewed along the longitudinal direction L.

As shown in FIG. 2, the device 2 has a device 20 for photographic imaging. The device 20 is used to generate photographic images of the heat exchanger 12 and to transmit them to a control unit 22 of the device 2. The control unit 22 can have a computer for evaluating photographic images, be connected to a computer for evaluating photographic images and/or be connected to a server for evaluating photographic images.

The control unit 22 is set up to detect an icing condition of the heat exchanger 12 and to determine a defrosting time on the basis of an evaluation of first photographic images.

Furthermore, the control unit 22 is set up to control a defrosting process carried out by means of the heating device 16 on the basis of an evaluation of second photographic images, wherein the evaluation of first photographic images is different from the evaluation of second photographic images. The control unit 22 can also be referred to as controller 22.

Both the first photographic images and the second photographic images are generated by the photographic imaging device 20 and transmitted to the control unit 22.

The device 20 for photographic imaging is a camera 20 which is set up both for photographic imaging in the visible wavelength range and for photographic imaging in the non-visible wavelength range and for this purpose has a sensor 24 for corresponding imaging in the said wavelength range.

The device 2 also has a temperature sensor 26, a pressure sensor 28 and a humidity sensor 30, which transmit signals to the control unit 22.

The device 2 is set up to carry out a method according to the disclosure described below.

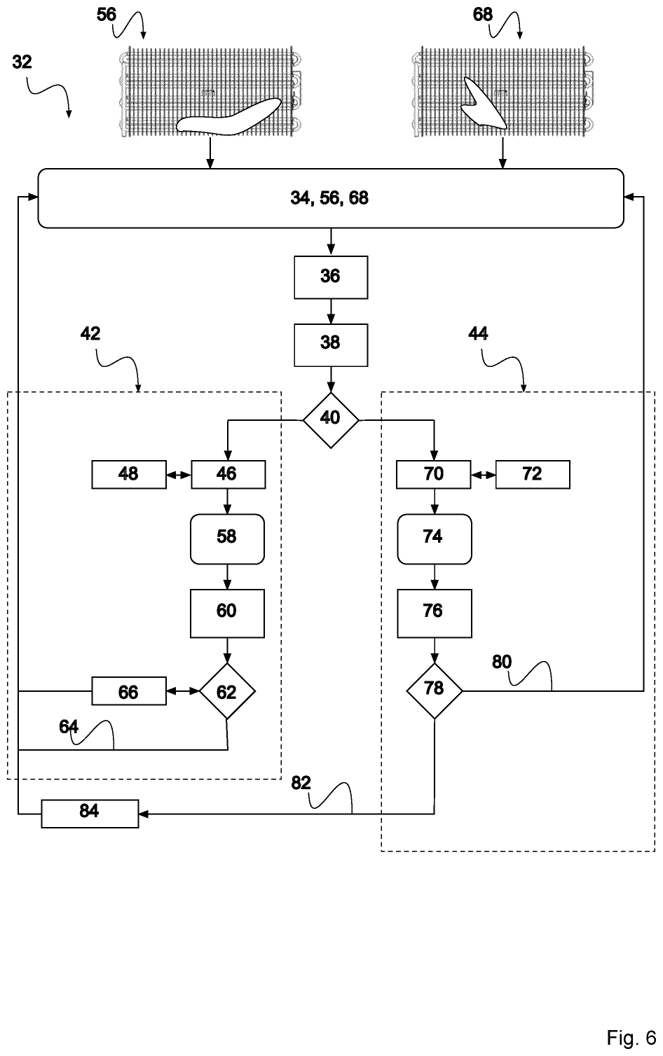

The flow diagram 32 according to FIG. 6 relates to the operation of the heat exchanger 12 of the device 2.

Block 34 of the flowchart 32 describes the sensor level of the method and represents signals from the sensors 26, 28 and 30 as well as the provision of first photographic Images of the heat exchanger 12 and/or the provision of second photographic images of the heat exchanger 12. Block 34 thus represents the input data of the method according to the disclosure, which are transmitted to a database 36.

This data is then processed or prepared in a further method step, which is represented by block 38.

According to step 40, it is checked whether the heating device 16 is switched on or whether the defrosting process is currently active. If the heating device 16 is not switched on and thus no defrosting process is active, the branch 42 is carried out, which concerns a detection of the icing state of the heat exchanger 12 and a determination of a defrosting time of the heat exchanger 12. If the heating device 16 is switched on and the defrosting process is therefore active, branch 44 is executed, which relates to controlling the defrosting process.

First, the method steps of branch 42 are described.

In a method step 46, a first photographic image of the heat exchanger 12 is evaluated. The evaluation is carried out using image evaluation software that is AI-based.

The first photographic image is a photographic image of the heat exchanger 12 in the visible wavelength range. The photographic image has been generated by means of the photographic imaging device 20.

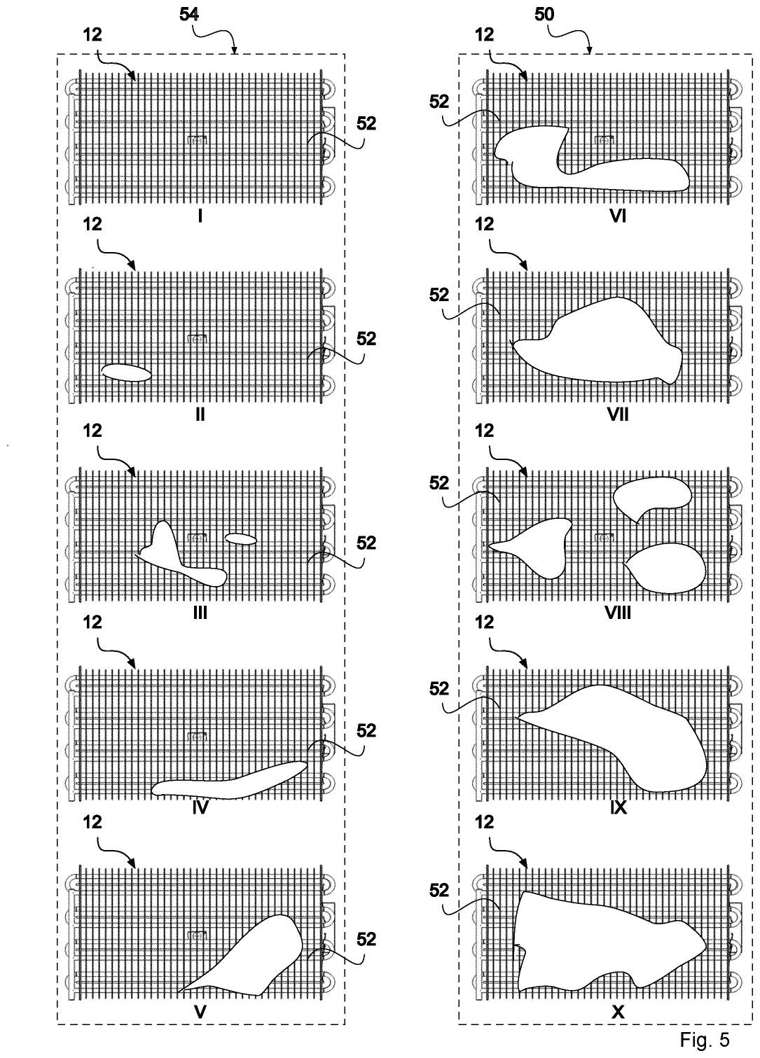

The AI model underlying the method steps 46 has been generated using training data represented by block 48. In particular, block 48 represents a machine learning, i.e. a statistical model, based on reference images manually analyzed and classified by skilled personnel. The AI model is therefore based on reference images of photographic images in the visible wavelength range, examples of which are shown in FIG. 5.

Here, a first group 50 shows reference images 52 of photographic images of the visible wavelength range for an icing condition of the heat exchanger 12 that requires defrosting. Further, a second group 54 shows reference images 52 of photographic images of the visible wavelength range for an icing condition of the heat exchanger 12 that does not require defrosting.

The reference images 52 of photographic images of the visible wavelength range of the heat exchanger 12 have been divided into ten classes according to the icing degree to be recognized on the reference images 52, which are numbered consecutively from I-X in the present case, with the icing degree increasing with ascending numbering.

The reference images 52 with icing degree I, II, III, IV and V have been assigned to the second group 54, while the reference images with icing degree VI, VII, VIII, IX, X have been assigned to the first group 50.

An image 56 of the heat exchanger 12 in the visible wavelength range taken by the photographic imaging device 20 is assigned to a class I-X by means of the AI model 46 in a method step 58 according to FIG. 6 and, on the basis of the assigned class, it is determined in a method step 60 on the basis of the associated group 50, 54 whether defrosting is required or not.

If no defrosting is required, the branch 42 restarts as a loop according to the path 64 starting from the branch 62.

If defrosting is required, a defrosting time is determined according to the block or method step 66 in order to initialize the defrosting. When the defrosting process is started, branch 44 of flowchart 32 is therefore run through, since the query or condition 40 now leads to branch 44 due to the heating device 16 being switched on.

The defrosting of the heat exchanger 12 is controlled by evaluating second photographic images 68. The second photographic images 68 are generated by means of the device 20 for photographic imaging and are images of the heat exchanger 12 in the non-visible wavelength range.

The evaluation of the second photographic images 68 is also based on an AI model 70 that has been generated on the basis of training data in a machine learning process according to the method step 72. In particular, the block 72 represents a machine learning, i.e. a statistical model, based on reference images manually evaluated and classified by skilled personnel.

The method steps 74 and 76 can be used to assign the photographic image 68 of the non-visible wavelength range to a class in analogy to the procedure described above with respect to the photographic images of the visible wavelength range, in order to stop the defrosting process depending on an icing condition of the heat exchanger 12.

If the assignment of the photographic image 68 of the non-visible wavelength range to a class indicates that defrosting is still required, the branch 44 is repeated according to path 80. If the assignment of the photographic image 68 of the non-visible wavelength range to a class indicates that no further defrosting is required, the path 82 leads to the method step 84, which causes the heating device 16 to be switched off.

Due to the heating device 16 being switched off, the branch 42 is now run through again in a loop until a required defrosting of the heat exchanger 12 is detected.

The signals from the sensors 26, 28, 30 can be used to check the plausibility of the image evaluation both during the detection of the icing condition and during the control of the defrosting process.

It may be provided that a first time interval, which is present between the provision and evaluation of two successive photographic images of the visible wavelength range, is greater than a second time interval, which is present between the provision and evaluation of two successive photographic images of the non-visible wavelength range.

It may be provided that the device 20 for photographic imaging is arranged inside the housing 4 according to an alternative design. In particular, it may be provided that the device 20 for photographic imaging is arranged within the housing 4 between the fans 8 and the heat exchanger 12.

It may be provided that the heat exchanger according to an alternative design is a so-called microchannel heat exchanger, which for example has parallel pipes for guiding a cooling medium and fins arranged in between.

1. A method including the following, steps:
operating a heat exchanger;
detecting an icing state of the heat exchanger and determining a defrosting time of the heat exchanger on the basis of an evaluation of first photographic images of the heat exchanger, and
starting a defrosting process of the heat exchanger, which is carried out by a heating device at the defrosting time and controlling the defrosting process on the basis of an evaluation of second photographic images of the heat exchanger;
wherein the evaluation of first photographic images is different from the evaluation of second photographic images.

2. The method according to claim 1,
wherein
the first photographic images are photographic images of a visible wavelength range.

3. The method according to claim 2,
wherein
the evaluation of the first photographic images is carried out by image evaluation software,
wherein two or more reference images of photographic images of the visible wavelength range are provided to the image evaluation software, and
wherein a comparison of the reference images with a respective first photographic image is carried out by the image evaluation software.

4. The method according to claim 3,
wherein
the image evaluation software is AI-based.

5. The method according to claim 3,
wherein
a first group of reference images of photographic images of the visible wavelength range shows an icing condition of the heat exchanger which requires defrosting, and
a second group of reference images of photographic images of the visible wavelength range shows an icing condition of the heat exchanger which does not require defrosting,
wherein a defrosting time is defined if one or more of the first photographic images are assigned by the image evaluation software to the first group of photographic images of the visible wavelength range.

6. The method according to claim 3,
wherein
the reference images of photographic images of the visible wavelength range are divided into two or more classes according to the icing degree to be recognized on the reference images.

7. The method according to claim 5,
wherein
the reference images are assigned to the first group or the second group on the basis of their respective class,
wherein one or more classes are assigned to the first group,
wherein one or more classes are assigned to the second group,
wherein a class assigned to the first group is not assigned to the second group, and vice versa.

8. The method according to claim 1,
wherein
the second photographic images are photographic images of a non-visible wavelength range

9. The method according to claim 8,
wherein
the second photographic images are evaluated using image evaluation software,
wherein two or more reference images of photographic images of the non-visible wavelength range are provided to the image evaluation software,
and wherein a comparison of the reference images with a respective second photographic image is carried out by the image evaluation software.

10. The method according to claim 9,
wherein
the image evaluation software is Al-based.

11. The method according to claim 9,
wherein
a first group of reference images of photographic images of the non-visible wavelength range shows an icing condition of the heat exchanger which requires defrosting and a second group of reference images of photographic images of the non-visible wavelength range shows an icing condition of the heat exchanger which does not require defrosting,
wherein a defrosting process is terminated if one or more of the second photographic images are assigned by the image evaluation software to the second group of reference images of photographic images of the non-visible wavelength range.

12. The method according to claim 9,
wherein
the reference images of photographic images of the non-visible wavelength range are divided into two or more classes according to the icing degree to be recognized on the reference images.

13. The method according to claim 11,
wherein
the reference images are assigned to the first group or the second group on the basis of their respective class,
wherein one or more classes are assigned to the first group,
where one or more classes are assigned to the second group,
where a class that is assigned to the first group is not assigned to the second group, and vice versa.

14. The method according to claim 8,
wherein
the evaluation of second photographic images is a thermal image evaluation of backradiated intensities in the non-visible wavelength range, wherein the second photographic images are thermal images.

15. The method according to claim 1,
wherein
the second photographic images of the evaluation are provided in grayscale.

16. The method according to claim 1,
wherein
a first time interval, which is present between the provision and evaluation of two successive photographic images of the first photographic images, is greater than a second time interval, which is present between the provision and evaluation of two successive photographic images of the second photographic images.

17. The method according to claim 1,
wherein
sensor data from one or more of the sensors listed below are used to determine the icing state and/or the defrosting time and/or to control the defrosting process: temperature sensor, pressure sensor, humidity sensor.

18. The method according to claim 1,
wherein
the evaluation of the first photographic images and/or the evaluation of the second photographic images is carried out at least partially by a server, wherein a controller of the heating device is connected to the server via a wired or wireless data connection, and/or
the evaluation of the first photographic images and/or the evaluation of the second photographic images is carried out at least partially by a computer assigned to the heat exchanger and the heating device, wherein a controller -of the heating device is connected to the computer via a wired or wireless data connection.

19. The method according to claim 1,
wherein
a service message and/or an alarm message is generated and output as a result of the evaluation of the first photographic images and/or as a result of the evaluation of the second photographic images; and/or
a number of photographic imaging devices for capturing the second photographic images is greater than a number of cameras for capturing the first photographic images;
and/or
exactly one device for photographic imaging, is provided for capturing the first photographic images;
and/or
two or more photographic imaging devices, are provided for capturing the second photographic images;
and/or a plurality of devices for photographic imaging, are provided for capturing the second photographic images, which are distributed along a longitudinal extension of the heat exchanger.

20. A device comprising:
a heat exchanger,
wherein the heat exchanger has a pipe which carries a cooling medium,
wherein the pipe is connected to a plurality of cooling fins of the heat exchanger,
a fan for conveying an air volume flow,
a heating device for defrosting the heat exchanger,
a device for photographic imaging, and
a control unit,
wherein the control unit is set up for detecting an icing state of the heat exchanger and for determining a defrosting time on the basis of an evaluation of first photographic images,
wherein the control unit is set up for controlling a defrosting process carried out by the heating device-on the basis of an evaluation of second photographic images, and
wherein the evaluation of first photographic images is different from the evaluation of second photographic images.

21. The device according to claim 20,
wherein
the first photographic images are photographic images of a visible wavelength range.

22. The device according to claim 20,
wherein
the second photographic images are photographic images of a non-visible wavelength range.

23. The device according to claim 20,
wherein the device for photographic imaging comprises a first camera with a sensor for photographic imaging in the visible wavelength range and a second camera with a sensor for photographic imaging in the non-visible wavelength range,
and/or
wherein the device for photographic imaging comprises a camera for photographic imaging both in the visible wavelength range and in the non-visible wavelength range,
and/or
wherein the device-for photographic imaging comprises a thermal imaging camera,
and/or
wherein the device for photographic imaging comprises an infrared camera.

24. The device according to claim 20,
wherein
one or more of the sensors listed below are provided: temperature sensor, pressure sensor, humidity sensor;
and/or
a number of photographic imaging devices for capturing the second photographic images is greater than a number of cameras for capturing the first photographic images;
and/or
exactly one device for photographic imaging is provided for capturing the first photographic images;
and/or
two or more photographic imaging devices are provided for capturing the second photographic images;
and/or
a plurality of devices for photographic imaging are provided for capturing the second photographic images, which are distributed along a longitudinal extension of the heat exchanger.

25. The device according to claim 20, wherein
the device is set up to carry out a method including the following steps:
operating a heat exchanger;
detecting an icing state of the heat exchanger and determining a defrosting time of the heat exchanger on the basis of an evaluation of first photographic images of the heat exchanger; and
starting a defrosting process of the heat exchanger, which is carried out by a heating device at the defrosting time and controlling the defrosting process on the basis of an evaluation of second photographic images of the heat exchanger;
wherein the evaluation of first photographic images is different from the evaluation of second photographic images.
